(19) United States
(12) Patent Application Publication
(10) Pub. No.: US 2024/0187830 A1
(43) Pub. Date: Jun. 6, 2024

(54) METHOD FOR RETRIEVING RESOURCE LABEL IN ONEM2M SYSTEM

(71) Applicant: Korea Electronics Technology Institute, Seongnam-si (KR)

(72) Inventors: Seong Yun KIM, Seoul (KR); Il Yeup AHN, Yongin-si (KR); Seung Myeong JEONG, Uiwang-si (KR); Nak Myoung SUNG, Gwangju-si (KR)

(73) Assignee: Korea Electronics Technology Institute, Seongnam-si (KR)

(21) Appl. No.: 17/796,493

(22) PCT Filed: Oct. 19, 2021
(86) PCT No.: PCT/KR2021/014591

§ 371 Date: Jul. 29, 2022

(30) Foreign Application Priority Data
Oct. 19, 2021 (KR) 10-2021-0139295

(51) Int. Cl. H04W 4/70; G16Y 40/35

(52) U.S. Cl. CPC H04W 4/70; G16Y 40/35

(57) ABSTRACT

Provided is a resource label retrieval method in a one M2M system. A resource information retrieval method according to an embodiment of the present disclosure includes retrieving, by the M2M system, labels of resources when a label retrieval request regarding resources is received, determining, by the M2M system, whether to return an interworking information label on which information regarding data interworking with another system is recorded, among the retrieved labels of the resources, and returning a label of a resource retrieved according to a result of the determining. Accordingly, when retrieval of a resource label is requested, an interworking information label is selectively/restrictively returned based on a type of an AE which requests or a type of a retrieval request, so that a service error caused by provision of unnecessary information can be prevented and information security can be strengthened.

### TECHNICAL FIELD

The present disclosure relates to information retrieval technology, and more particularly, to a method for retrieving a resource label for data interworking between data platforms which employ different standards.

### BACKGROUND ART

Resource discovery of one machine to machine (oneM2M) is to search what resource exists on a oneM2M data platform. As shown in FIG. 1, in response to a discovery request, a list of resources satisfying a condition is provided.

In the oneM2M, labels may be set for every resource, and the label may set/store characteristics of the resource, a hash tag, meta data, etc. In the case of discovery, resources are searched through labels.

According to oneM2M standards, data interworking technology with various other standards is defined and supported, and an object for interworking may be selected and information necessary for interworking may also be set/stored in a label.

Accordingly, an interworking proxy application entity (IPE), which is an application entity (AE) having to perform data interworking, necessarily requires an interworking information label on which information regarding data interworking is recorded.

However, in the case of an AE which provides a normal service rather than data interworking, label information for interworking is not required. When an interworking information label is added to a resource while the AE provides a general service, the label may have rather a bad influence on service provision.

However, as shown in FIG. 2, the same retrieval result may be provided when a label is retrieved, regardless of what the AE is. Accordingly, when a label of a resource is retrieved, there is a need for a method for distinguishing between an interworking information label and a normal information label and retrieving/returning.

### DISCLOSURE

### Technical Problem

The present disclosure has been developed in order to address the above-discussed deficiencies of the prior art, and an object of the present disclosure is to provide a resource information retrieval method which selectively/restrictively returns an interworking information label according to a type of an AE or a retrieval type when retrieval of a resource label is requested.

### Technical Solution

According to an embodiment of the present disclosure to achieve the above-described object, a resource information retrieval method includes: a step of receiving, by an M2M system, a label retrieval request regarding a resource; a step of retrieving, by the M2M system, labels of resources; a step of determining, by the M2M system, whether to return an interworking information label on which information regarding data interworking with another system is recorded, among the retrieved labels of the resources; and a step of returning, by the M2M system, a label of a resource retrieved according to a result of the determining.

The step of determining may include: a step of identifying, by the M2M system, a type of an application entity (AE) which requests label retrieval; and a first determination step of, when the identified type is an interworking proxy application entity (IPE) type, determining, by the M2M system, to return an interworking information label.

The first determination step may include: a step of identifying, by the M2M system, interworking technology specified on information of the AE; and a second determination step of, when the interworking technology is specified, determining, by the M2M system, to return an interworking information label related to the specified interworking technology.

The first determination step may further include a third determination step of, when the interworking technology is not specified, determining, by the M2M system, to return all of the retrieved interworking information labels.

In addition, the second determination step may include determining to return the interworking information label related to the specified interworking technology along with other normal information labels of the retrieved resources, and the third determination step may include determining to return the interworking information labels along with other normal information labels retrieved.

The step of determining may further include a fourth determination step of, when the identified type is a normal type, determining, by the M2M system, to return only a normal information label except for the interworking information label.

The step of determining may include: a step of identifying, by the M2M system, a retrieval attribute of the retrieval request; and a fifth determination step of, when the identified retrieval attribute indicates interworking information retrieval, determining, by the M2M system, to return the interworking information label.

The fifth determination step may include determining to return the interworking information label along with other normal information labels retrieved.

The step of determining may further include a sixth determination step of, when the identified retrieval attribute indicates normal information retrieval, determining, by the M2M system, to return only a normal information label except for the interworking information label.

According to another embodiment of the present disclosure, an M2M system includes: a communication unit configured to communicate with an application entity (AE) to receive a label retrieval request regarding resources from the AE; and a processor configured to retrieve labels of resources requested to be retrieved, to determine whether to return an interworking information label on which information regarding data interworking with another system is recorded, among the retrieved labels of the resources, and to return a label of a resource retrieved according to a result of the determining to the AE through the communication unit.

According to another embodiment of the present disclosure, a resource information retrieval method includes: a step of requesting, by an application entity (AE), an M2M system to retrieve resources; a step of returning, by the M2M system, retrieved resources to the AE; a step of requesting, by the AE, the M2M system to retrieve labels of the retrieved resources; a step of retrieving, by the M2M system, labels of resources; a step of determining, by the M2M system, whether to return an interworking information label on which information related to data interworking with another system is recorded among the retrieved labels of the resources; and a step of returning, by the M2M system, the retrieved labels of the resources selectively to the AE according to a result of the determining.

According to another embodiment of the present disclosure, an IoT system includes: an application entity (AE) configured to request an M2M system to retrieve resources, and to request retrieval of labels of the retrieved resources; and an M2M system configured to return resources requested to be retrieved to the AE, to retrieve labels of the resources requested to be retrieved, to determine whether to return an interworking information label on which information related to data interworking with another system is recorded among the retrieved labels of the resources, and to return the retrieved labels of the resources selectively to the AE according to a result of the determining.

### Advantageous Effects

According to embodiments of the present disclosure as described above, when retrieval of a resource label is requested, an interworking information label is selectively/restrictively returned based on a type of an AE which requests or a type of a retrieval request, so that a service error caused by provision of unnecessary information can be prevented and information security can be strengthened.

### DESCRIPTION OF DRAWINGS

FIG. 1 is a view provided to explain resource discovery;

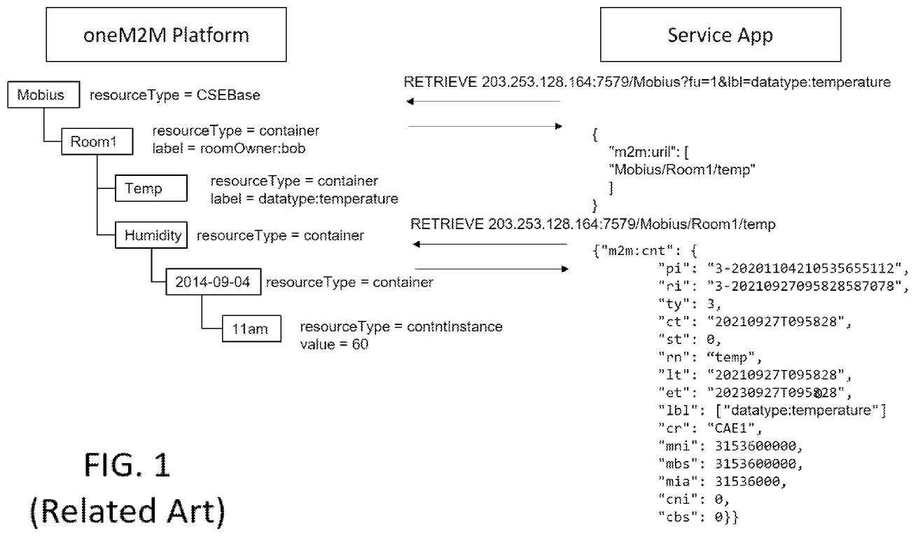

FIG. 2 is a view provided to explain resource label retrieval;

FIG. 3 is a view illustrating an IoT system to which the present disclosure is applicable;

FIG. 4 is a flowchart provided to explain a resource information retrieval method in a oneM2M system according to an embodiment of the present disclosure;

FIG. 5 is a flowchart provided to explain a resource information retrieval method in a oneM2M system according to another embodiment of the present disclosure;

FIG. 6 is a flowchart provided to explain a resource information retrieval method in a oneM2M system according to still another embodiment of the present disclosure;

FIG. 7 is a flowchart provided to explain a resource information retrieval method in a oneM2M system according to yet another embodiment of the present disclosure; and

FIG. 8 is a block diagram of the oneM2M platform shown in FIG. 3.

### BEST MODE

Hereinafter, the present disclosure will be described in more detail with reference to the drawings.

An embodiment of the present disclosure suggests a resource information retrieval method in a oneM2M system. Specifically, there is provided a method of refraining from providing information regarding data interworking when there is no application entity (AE) that sets data interworking with other systems in the oneM2M system.

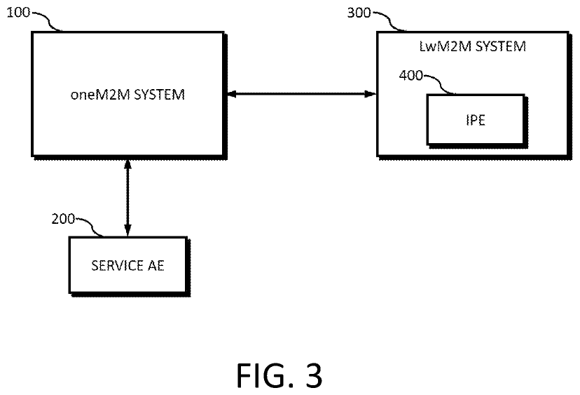

FIG. 3 is a view illustrating an IoT system to which the present disclosure is applicable. The IoT system to which the present disclosure is applicable may include a oneM2M system 100, a service AE 200, a lightweight M2M (LwM2M) system 300, and an interworking proxy application entity (IPE) 400.

The oneM2M system 100 is a data platform that collects data from various IoT devices, and stores the data in a resource.

The service AE 200 is an AE that provide a service necessary for a user by utilizing data stored in resources generated in the oneM2M system 100.

Like the oneM2M system 100, the LwM2M system 300 is a data platform that collects and stores data from various IoT devices. However, both systems employ different standards.

The IPE 400 is an AE for setting data interworking between the LwM2M system 300 and the oneM2M system 100. That is, the IPE 400 may interwork data of the LwM2M system 300 with data of the oneM2M system 200, or in reverse, may interwork data of the oneM2M system 100 with data of the LwM2M system 300.

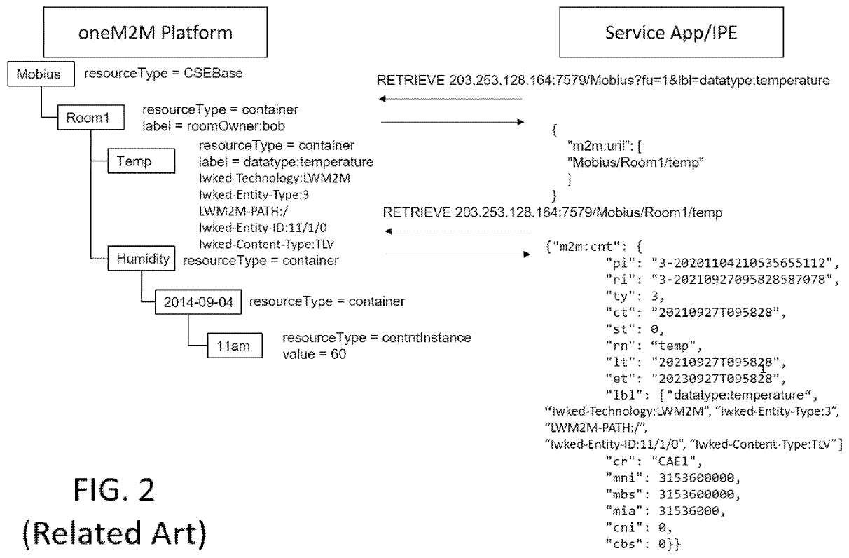

Since the IPE 400 should interwork the LwM2M system 300 and the oneM2M system 100, the IPE 400 should retrieve and acquire an interworking information label, which is a label related to data interworking between both systems, from a resource of the oneM2M system 100. The interworking information label refers to an Iwked-Technology label, an Iwked-Entity-Type label, an LWM2M-PATH label, an IwKed-Entity-ID label, an IwKed-Content-Type label among the labels suggested in FIG. 2.

On the other hand, the service AE 200 does not require the interworking information label, and requires only a normal information label. The interworking information label may be rather a hindrance to service provision of the service AE 200.

Accordingly, in an embodiment of the present disclosure, in retrieving a label of a resource as resource information, the oneM2M system 100 may restrict to providing a label on which interworking information with the LwM2M system 300 is recorded.

That is, the oneM2M system 100 may determine in advance whether to return a label on which information regarding interworking with the LwM2M system 300 is recorded, among labels of resources requested to be retrieved, and may selectively return.

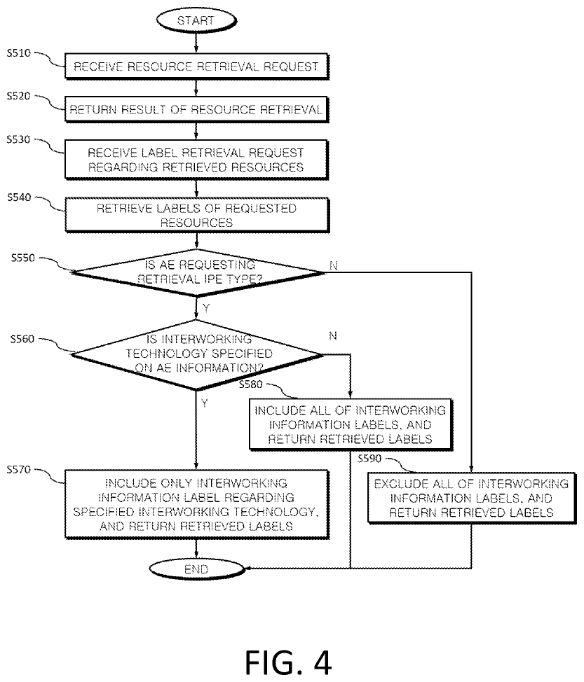

FIG. 4 is a flowchart provided to explain a resource information retrieval method in a oneM2M system according to an embodiment of the present disclosure.

When a resource retrieval request is received from the AE (S510), the oneM2M system 100 returns a result of retrieving resources (S520). Thereafter, the oneM2M system 100 may receive a label retrieval request regarding the resources retrieved at step S520 from the AE (S530).

Then, the oneM2M system 100 retrieves labels of the requested resources (S540). In addition, the oneM2M system 100 identifies a type attribute of the AE which transmits the retrieval request (S550). The retrieval request at steps S510 and S530 may include information regarding the AE which is a requester. At step S550, the AE type may be identified by referring to the AE information.

When the AE type identified at step S550 is an IPE type, that is, when the IPE 400 of the LwM2M system 300 requests retrieval (S550-Y), the oneM2M system 100 may identify whether there is an interworking technology attribute in AE information (S560).

The IPE 400 illustrated in FIG. 3 is for data interworking between the LwM2M system 300 and another system, and the interworking technology attribute included in the AE information of the IPE 400 specifies “LwM2M”.

When interworking technology is specified on the AE information (S560-Y), the oneM2M system 100 may include only an interworking information label regarding the specified interworking technology, and may return the resource labels retrieved at step S540 to the AE (S570).

That is, at step S570, an interworking information label related to interworking technology that is not specified, other than the interworking information label related to the specified interworking technology, among the labels of the resources retrieved at step S540, is not returned.

In the case of FIG. 3, to the IPE 400 of the LwM2M system 300, the interworking information label for data interworking between the LwM2M system 300 and the oneM2M system 100, and labels of other normal information besides interworking information are returned. However, an interworking information label for interworking between other systems than the LwM2M system 300, for example, an NGSI-LD system (not shown), a Modbus system (not shown), an OMA-DM system (not shown), and the oneM2M system 100 is not returned.

On the other hand, when interworking technology is not specified on the AE information at step S560 (S560-N), the oneM2M system 100 may include all of the interworking information labels, and may return the resource labels retrieved at step S540 to the AE (S580). That is, at step S580, all of the resource labels retrieved at step S540 are returned to the AE.

On the other hand, when the AE type identified at step S550 is not the IPE type but a normal AE, that is, when the service AE 200 requests retrieval (S550-N), the oneM2M system 100 may exclude all of the interworking information labels, and return the resource labels retrieved at step S540 to the AE (S590). That is, at step S590, only normal information labels among the resource labels retrieved at step S540 may be returned to the AE.

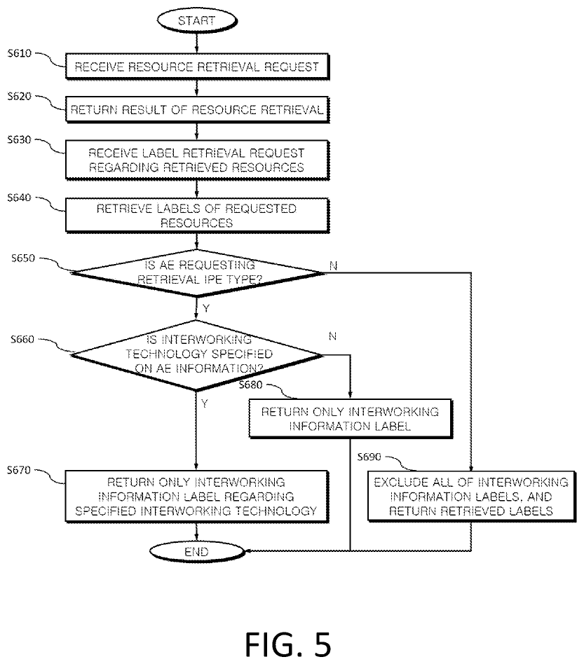

FIG. 5 is a flowchart provided to explain a resource information retrieval method in the oneM2M system according to another embodiment of the present disclosure.

In FIG. 5, steps S610 to S660 and step S690, except for steps S670 and S680, are the same as steps S510 to S560 and step S590, except for step S570 and step S580 of FIG. 4.

Step S670 differs from step S570 of FIG. 4 in that only the interworking information label related to the specified interworking technology is included in the resource labels returned to the AE, and other normal information labels are not included.

In addition, step S680 differs from step S580 of FIG. 4 in that only the interworking information label is included in the resource labels returned to the AE, and other normal information labels are not included.

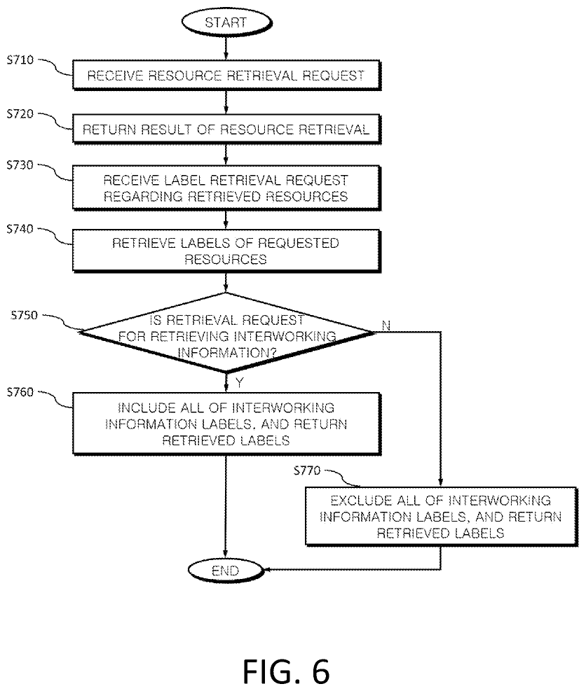

FIG. 6 is a flowchart provided to explain a resource information retrieval method in the oneM2M system according to still another embodiment of the present disclosure.

Since steps S710 to S740 of FIG. 6 are the same as steps S510 to S540 of FIG. 4, detailed descriptions thereof are omitted.

After the labels are retrieved (S740), the oneM2M system 100 identifies a retrieval attribute of the label retrieval request (S750). That is, it is identified whether the retrieval attribute included in the label retrieval request received at step S730 indicates interworking information retrieval or normal information retrieval.

When the retrieval attribute identified at step S750 indicates interworking information retrieval, that is, when the IPE 400 of the LwM2M system 300, an IPE (not shown) of an NGSI-LD system, an IPE (not shown) of a Modbus system, or an IPE (not shown) of an OMA-DM system requests retrieval of interworking information labels (S750—Y), the oneM2M system 100 may include all interworking information labels, and may return the resource labels retrieved at step S740 to the AE (S760). That is, at step S760, all of the resource labels retrieved at step S740 are returned to the AE.

When the retrieval attribute identified at step S750 indicates normal information retrieval, that is, when the service AE 200 requests retrieval of normal information labels (S750—N), the oneM2M system 100 may exclude all of the interworking information labels, and may return the resource labels retrieved at step S740 to the AE (S770). That is, at step S770, only normal information labels among the resource labels retrieved at step S740 are returned to the AE.

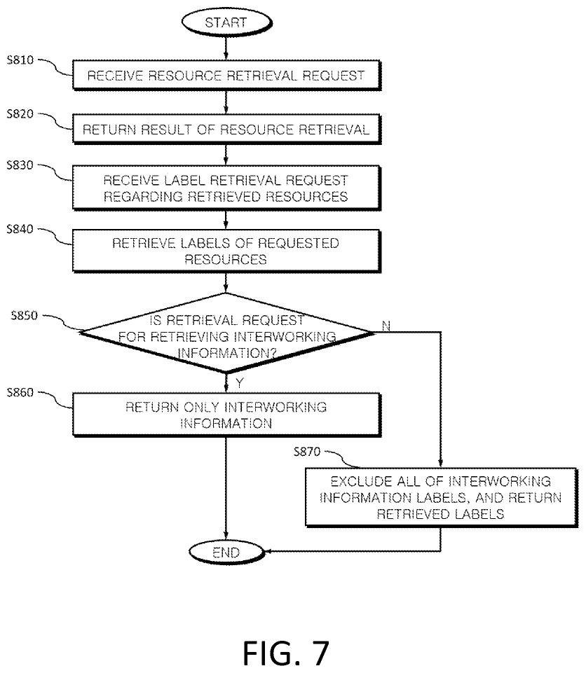

FIG. 7 is a flowchart provided to explain a resource information retrieval method in the oneM2M system according to yet another embodiment of the present disclosure.

In FIG. 7, steps S810 to S850 and step S870, except for step S860, are the same as steps S710 to S750 and step S770, except for step S760 of FIG. 6.

Step S860 differs from step S760 of FIG. 6 in that only the interworking information label is included in the resource labels returned to the AE, and other normal information labels are not included.

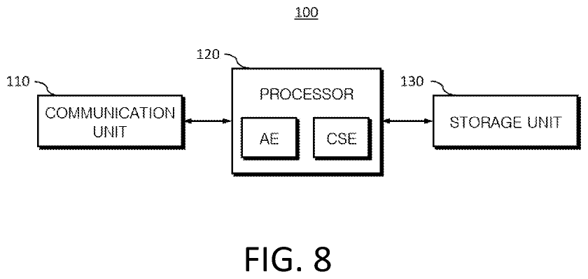

FIG. 8 is a block diagram of the oneM2M platform 100 shown in FIG. 3. As shown in the drawing, the oneM2M platform 100 may be implemented by a server system including a communication unit 110, a processor 120, and a storage unit 130.

The communication unit 110 is a communication means for communicating with IoT devices and the LwM2M system 200, the IPE 400. The processor 120 may include at least one application entity (AE) and a common service entity (CSE). The AE may not be included.

In an embodiment of the present disclosure, the processor 120 may perform procedures shown in FIGS. 4 to 7 to provide a result of retrieving to the service AE 200 and the IPE 400 differentially. The storage unit 130 provides a storage space necessary for functions and operations of the processor 120.

Up to now, the resource label retrieval method in the oneM2M system has been described with reference to preferred embodiments.

The technical concept of the present disclosure may be applied to a computer-readable recording medium which records a computer program for performing the functions of the apparatus and the method according to the present embodiments. In addition, the technical idea according to various embodiments of the present disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the art without departing from the scope of the present disclosure claimed in claims, and also, changed embodiments should not be understood as being separate from the technical idea or prospect of the present disclosure.

1. A resource information retrieval method comprising:
a step of receiving, by an M2M system, a label retrieval request regarding a resource;
a step of retrieving, by the M2M system, labels of resources;
a step of determining, by the M2M system, whether to return an interworking information label on which information regarding data interworking with another system is recorded, among the retrieved labels of the resources; and
a step of returning, by the M2M system, a label of a resource retrieved according to a result of the determining.

2. The method of claim 1, wherein the step of determining comprises:
a step of identifying, by the M2M system, a type of an application entity (AE) which requests label retrieval; and
a first determination step of, when the identified type is an interworking proxy application entity (IPE) type, determining, by the M2M system, to return an interworking information label.

3. The method of claim 2, wherein the first determination step comprises:
a step of identifying, by the M2M system, interworking technology specified on information of the AE; and
a second determination step of, when the interworking technology is specified, determining, by the M2M system, to return an interworking information label related to the specified interworking technology.

4. The method of claim 3, wherein the first determination step further comprises a third determination step of, when the interworking technology is not specified, determining, by the M2M system, to return all of the retrieved interworking information labels.

5. The method of claim 4, wherein the second determination step comprises determining to return the interworking information label related to the specified interworking technology along with other normal information labels of the retrieved resources, and
wherein the third determination step comprises determining to return the interworking information labels along with other normal information labels retrieved.

6. The method of claim 1, wherein the step of determining further comprises a fourth determination step of, when the identified type is a normal type, determining, by the M2M system, to return only a normal information label except for the interworking information label.

7. The method of claim 1, wherein the step of determining comprises:
a step of identifying, by the M2M system, a retrieval attribute of the retrieval request; and
a fifth determination step of, when the identified retrieval attribute indicates interworking information retrieval, determining, by the M2M system, to return the interworking information label.

8. The method of claim 7, wherein the fifth determination step comprises determining to return the interworking information label along with other normal information labels retrieved.

9. The method of claim 7, wherein the step of determining further comprises a sixth determination step of, when the identified retrieval attribute indicates normal information retrieval, determining, by the M2M system, to return only a normal information label except for the interworking information label.

10. An M2M system comprising:
a communication unit configured to communicate with an application entity (AE) to receive a label retrieval request regarding resources from the AE; and
a processor configured to retrieve labels of resources requested to be retrieved, to determine whether to return an interworking information label on which information regarding data interworking with another system is recorded, among the retrieved labels of the resources, and to return a label of a resource retrieved according to a result of the determining to the AE through the communication unit.

11. A resource information retrieval method comprising:
a step of requesting, by an application entity (AE), an M2M system to retrieve resources;
a step of returning, by the M2M system, retrieved resources to the AE;
a step of requesting, by the AE, the M2M system to retrieve labels of the retrieved resources;
a step of retrieving, by the M2M system, labels of resources;
a step of determining, by the M2M system, whether to return an interworking information label on which information related to data interworking with another system is recorded among the retrieved labels of the resources; and
a step of returning, by the M2M system, the retrieved labels of the resources selectively to the AE according to a result of the determining.

12. An IoT system comprising:
an application entity (AE) configured to request an M2M system to retrieve resources, and to request retrieval of labels of the retrieved resources; and
an M2M system configured to return resources requested to be retrieved to the AE, to retrieve labels of the resources requested to be retrieved, to determine whether to return an interworking information label on which information related to data interworking with another system is recorded among the retrieved labels of the resources, and to return the retrieved labels of the resources selectively to the AE according to a result of the determining.
